(19) United States
(12) Patent Application Publication
(10) Pub. No.: US 2021/0195309 A1
(43) Pub. Date: Jun. 24, 2021

(54) Wireless headphones

(71) Applicant: James Filomio, JR., Bronx, NY (US)

(72) Inventor: James Filomio, JR., Bronx, NY (US)

(21) Appl. No.: 16/724,313

(22) Filed: Dec. 22, 2019

(51) Int. Cl. H04R 1/10; G06F 3/16

(52) U.S. Cl. CPC H04R 1/1041; H04R 1/1025; G06F 3/165; H04R 2420/07; H04R 1/1008; G06F 3/162; H04R 2420/09; G06F 3/167

(57) ABSTRACT

A headphone that stores audio files directly to the said device so the unit can be used without any wires, Bluetooth, or the need to carry a power source. The said invention is single unit that plays back the stored files in an order of the user's command. Audio files are downloaded through a USB port to the said device. There is a touchscreen that controls the file placement, scrolling, shows battery life, contacts, wifi signals and connections. A keyboard for file naming and contacts numbers. Audio can be paused, rewound, fast-forward. The said device can make and receive phone calls and text messages through it voice command talk transmitter. The said device can make a wifi connection for the user to listen to live audio from any website, podcast or social media. The device is powered by rechargeable batteries. Audio from any means other than the downloaded files could be recorded. The said invention will store the recorded audio, the user can create a file and a name, and play back the audio at any giving time.

Wireless headphones that stores, music and other audio files, with Internet service, text and call features. The said invention is a headphone that has the ability for the user to download music or any audio files into the headphone, where it will be stored and be used to be played back through the speakers. The said invention does not need to be connected to any other device, with a wire or wireless, to play audio files. The said invention stores the audio files to the headphones. The said invention also has the feature of receiving audio text messages and phone calls. The said invention can also make phone calls and place audio text messages. The said invention has the feature of internet service that allows the user to listen to live audio or pre-recorded audio through an online site of their choice.

### BACKGROUND OF INVENTION

Wireless headphones that stores music and other audio files, with internet service, text and call features, is an invention initially invented with runners in mind. The said invention will eliminate the user of having to carry with them a device that stores the audio, such as a smartphone or other audio storing device and uses the headphones as an instrument to hear the audio. The said invention as a USB port that is used to download music or audio files directly to the headphones, were the headphones will store the audios files. The said invention has a touchscreen that allows the user to see their files, contacts and scroll and choose the audio file they wish to hear or the contact they wish to call or text.

Wireless headphones that stores music and other audio files, with internet service, text and call features, has two speakers such as traditional headphones. There is a volume dial on the side of the said inventions head piece that also acts as an on/off switch when adjusted in one direction to the end. The said invention also has an answer button for when calls want to be connected as well as when text messages want to be heard through the headphones speakers. The said invention as an alert pager that signal the user of an incoming call or text message. There is a talking receiver in the said inventions headpiece that the user will talk into when on a call or to relay a text message. The said invention has a voice activated system that will allow the user to make calls or place text to a contact list on the headphones.

The said invention as a charging port

The Wireless headphones that stores music and other audio files, with internet service, text and call features will eliminate the user to have to carry another device to listen to audio when running or working out. When thinking about the uses and features of such an invention it was realized the said invention can be used by any person at any time. The said invention will make it easier to keep your hands free while listening to audio or while connected to the internet or a podcast, and at the same time being able to take and make phone calls, and receiving and placing texts.

### BRIEF SUMMARY OF INVENTION

The Wireless headphones that stores music and other audio files, with internet service, text and call features is designed for the user to wear the headphones to listen to audio, that is downloaded directly to the headphones through the USB port. There is a touchscreen on the side of the headphones that allows the user to pick from a play list they downloaded to the headphones. Audio can also be listened to directly from an internet connection, where the user can listen to podcast or other website applications. The said invention allows the users a true hands free experience, with not having to hold another device that is wired or Bluetooth connected to the headphones that stores the audio. The said invention stores audio file directly to the headphones.

The said invention as a feature that allows the user to receive and make phone calls without removing the headphones. The user can store contacts to the headphones and place calls with voice command. Also incoming calls can be received with a voice command answer feature or a push button. Text messages can be received as well as placed through the same voice command feature and or push button. The said invention has a talking receiver that is mated to the headphones that the user talks into for phone conversations and listens through the headphone speakers. The same talking receiver is used to translate outgoing text messages. The incoming text messages with be translated through the speakers on the headphones.

The Wireless headphones that stores music and other audio files, with Internet service, text and call features, has a charging port to charge the battery on the headphones.

The said invention features an answer button located on the headphones that is used to pick up and hang up calls. If the button is pressed twice the incoming call or text will not be answered.

The said invention features a volume dial that controls the speakers volume. If the user turns the volume dial downward to the end of its rotation, the speakers will turn off.

The said invention features an touchscreen that will display the users files as well as the means to connect to the Internet. With the USB port, the headphones could be connected to a computer and have files download from the computer to the headphones. With the USB port the user can also set the headphones up with internet service and program the headphones to a network, and also add a password to protect the headphones if lost.

The Wireless headphones that stores music and other audio files, with Internet service, text and call features, is an device that the users wears over their ears and plays audio files that were downloaded and stored on the headphones as well as the said invention can connect to an internet connection and the user could listen to live events, podcast or other audio applications that the internet has to offer. The said invention can also make and receive phone calls and text messages and record audio

### BRIEF DESCRIPTION OF THE DRAWINGS

FIG. 1 of the drawings illustrates the components of the said invention as a whole.

(5) is the power inlet for charging the headphones.

(15) is the speaker. There is another speaker on the opposite side in the headphone not shown. The speakers (15) relay audio to the user in terms of sound, as well as phone conversations and automated text readings. The speakers (15) also incorporates a sound when an incoming call or message is delivered.

(10) is the talking transmitter. This is where the user's voice is heard to relay voice commands to the headphones for text messages, phone conversations and other headphone commands.

(20) illustrates the USB port. This is where the user can download audio files to be stored on the headphones. The USB port (20) is not limited to flash drives or other devices for downloading files to the headphone. The USB port (20) is also used to program the headphones for contact information, playlist and not limited to other functions.

(25) illustrates the call answer button. When a call or text comes in, a small tone or vibration will be heard through the speakers (15), if the user wishes to answer the call or hear the incoming text read to them, they'll press the answer button (25). Upon pressing the answer button (25), the audio will be cut off of the speakers (15) and the user will either hear their texts read to them through the speakers (15) or hear the person on the other line voice to start the conversation. If the answer button is pressed twice the incoming call or text will be ignored.

(30) illustrates the on/off switch for the ringer. With the on/off switch (30) in the off position, the user will not hear incoming calls or text notifications. With the ringer on/off switch (30) on, the user will hear a tone or a vibration when an incoming text or phone call is coming through.

(35) illustrates the volume dial. The volume dial (35) adjusts the sound volume that goes through the speakers (15). If the volume dial (35) is adjusted all the way to the volume down position, it will shut off the said device.

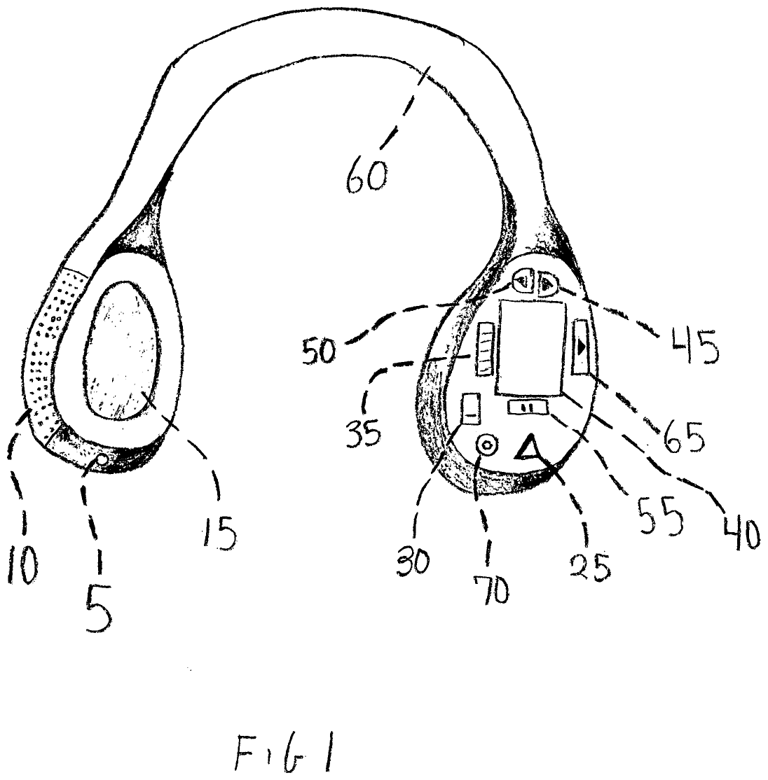

(40) illustrates the touchscreen. The touchscreen (40) is located on the side of one of the headsets as shown in FIG. 1. The touchscreen (40) is where the user can see all there downloaded files, play list, contacts and battery life, but not limited to other information. Files on the touchscreen (40) can be viewed by the user swiping their finger up and down on the screen, this will move the files accordingly to the user's finger movement. To select a file on the touchscreen (40) the user can use their finger to highlight and click on the selected file.

The touchscreen (40) is used when the user is downloading files or contacts, selecting a playlist, checking battery charge, but not limited to other functions. Any time the user connects the headphone to the USB port (20), or the charging port (5) the touchscreen (40) will display the information. The touchscreen (40) will be the part of the said invention that the user uses to add/delete files, see that the headphones are charging, change contacts, but not limited to other functions.

(45, 50) are the rewind and fast forward buttons (65) is the play button. (70) is the record button.

(55) Illustrates the pause button

(60) Illustrates the housing of the said invention that mates all the components together and holds the said invention in place while in use by the user.

### DETAILED DESCRIPTION OF THE INVENTION

The said invention, The Wireless headphones that stores music and other audio files, with internet service, text and call features, is a device that is placed over the users head and the headphones cover their ears.

The said invention, allows the user to download music or any audio files directly to the headphones where it could be stored and played back at any time. This allows the user not to have to carry another device with them that relays the audio to the headphone either by wire or wireless signal.

The said invention, has a USB port (20). At this connection, the user can connect to any source that transfers files. Through the USB port (20) the user can download audio files from a computer, smartphone or a flash drive, but not limited to other devices. The headphones will store the audio files for play back at the users demand by powering up the headphones with the on/off volume dial (35). Then with the use of the touchscreen (40) the download audio files will appear and the user can swipe the touchscreen (40) to find the file they want to play. By tapping the highlights area on the touchscreen (40) the audio file will begin to play and the user places the headphones over their ears.

The said invention, on/off volume dial (35) adjusts the volume of the speakers (15). The on/off volume dial (35) when dialed to the direction of lower volume, the dial will turn off the headphones when full dialed down. Turning the on/off volume dial (35) upward will power on the headphones and adjust the volume.

The said invention, has two speakers (15) that play the audio as well as alerts the user, with beeps, but not limited to other sounds, that they have an incoming text message or phone call. The speakers (15) are also used to hear the voice of the person calling them, but not limited to message playbacks, voicemails or any other audio sound recording. Through the speakers (15) the incoming text messages will be transferred over from type to audio playback and listened to through the speakers (15).

The said invention, has a talking transmitter (10). The talking Transmitter (10) is the mouth piece of the headphones that relays the users voice to the person their talking to, to hold conversations. But not limited to voicemails, text messages, device commands and other functions. The talking transmitter (10) can also command the headphone with the user's voice commands to place calls to contact stored in the headphones, speak text messages to contacts but not limited to other functions.

The said invention, has a ringer on/off button (30). If the user wishes not to have any incoming calls or text alerts, the ringer on/off button (30) will allow or not allow a notification signal to be heard by the user through the speakers (15). The ringer on/off button (30) is a simple up/down switch and is not limited to any other type of button, knob or dial.

The said invention, as a charging port (5). The said invention works off rechargeable batteries. To charge the headphones, a charging wire will come with the headphones. The user will plug the charging wire into the charging port (5) on the headphones to any power electrical outlet. When the headphones are powered on by the volume dial (35) a small icon on the touchscreen (40) will show the charge level of the headphones

To use the said invention, the user will charge the headphones to a level according to the amount of use they're going operate the said invention. A full charge is the optimal starting point. To turn on the said invention, the user will spin the volume dial (35) upward from the off position. This will power on the headphones as well as control the volume to the speakers (15). The user will then connect the said invention to any device that can transfer audio files, such as a computer, smartphone, but not limited to other devices. The transfer of files is accepted through the USB port (20). It is at the USB port (20) the files could be downloaded or deleted, as well as the user's contact list. As the files are downloaded, the touchscreen (40) will display all the downloaded files. Also on the touchscreen (40) the user's contact lists will appear. The touchscreen (40) will highlight a selected file as the user scrolls up or down on the touchscreen (40) with their finger. When a file is reached and highlighted, the user will tap on the highlighted area and that file will begin to play through the headphones. The headphones have the capability to connect to the internet. Where the user can listen to live shows, podcast or any other audio platform.

When a call or text comes in, the user will hear a signal from the speaker, if the user accepts the call or text, they will press the answer button (25) on the headphones. This will cut the audio and accept the phone call. The phone call will be heard through the speakers (15) and the user's voice will be relayed through the talking transmitter (10). If a call or text is wished to not be answered, pressing the answer button (25) twice will ignore the incoming call or text and stop the notification signal.

When a text message is incoming, the user will press the answer button (25) cutting off the audio and the incoming text will be read through the speakers (15).

When the user wants to place a call or text, they'll press the answer button (25), cutting off the audio, Then with voice command, they'll say a command to call or text a member on the contact list.

If the user wishes to pause the audio, pressing the pause button (55) will accomplish that command.

To fast forward the audio, pressing the fast forward button (45) will cause the said invention to skip to the beginning of the next song, if it's a music file. For books, pressing the fast forward button (45) will start the next page, but not limited to next chapter. Holding down the fast forward button (45) will skip the audio to that of where the user lets go of the said button (45).

Illustration (50) is the rewind button. Pressing this button will rewind the song to the beginning. For books the fast forward button (50) will restart from the last page, but not limited to the last chapter. Holding down the said button (50) will skip the audio to that of where the user lets go of the said button (50).

Illustration (65) is the play button. The play button starts the audio through the speakers (15)

Illustration (70) is the record button. Pressing the record button (70) can record phone calls, audio from internet shows, podcast, internet radio, but is not limited to other audio.

I claim:

1. A Headphone device capable of having audio files downloaded and stored directly to the said Invention for play back.

2. The device as in claim 1, wherein said device comprising
A. A charging port
B. Talking transmitter
C. Speakers
D. USB port
E. Call or text answer button
F. Ringer on/off button
G. Volume dial
H. On/off button
I. Touchscreen
J. Housing
K. Battery/batteries
L. Pause button
M. Fast forward button
N. Rewind button
O. A play button
P. A record button

3. The device as in claim 1, wherein said device has a housing that mates the comprising components and holds the said invention to the user's head.

4. The device as in claim 1, wherein said invention has a volume dial that controls the volume of the speakers and powers on and off the said invention

5. The device as in claim 1, wherein the said invention has a charging port to charge the said device battery. The said invention is not limited to more than one battery, shape size or location. The said invention battery or batteries, are rechargeable and are charged through the charging port that is powered by an external power source such as an electrical wall power outlet, but not limited to other power sources for recharging. The said invention has a separate power charging wire that connects the said invention to the external power source for recharging.

6. The device as in claim 1, wherein said invention has a USB port that connects the said invention to any device, such as a computer, Flash drive, Smartphone, but not limited to other devices. The USB port is the component of the said invention that is used to connect the said invention to another devices in order to transfers audio files to and from the device/s to the said invention. The USB port can also be used to remove files. The said invention is not limited to downloading other files or information.

7. The device as in claim 1, wherein said invention, stores the audio files downloaded from other devices. The stored audio files on the said invention can be played back, the files can be adjusted by the user to play in repeat form or continuous, but not limited to other formats. The said invention features a fast forward, pause and rewind button, at any point at the user's commands, volume can be adjusted, and there does not need another type of connections to the headphone to operate. The said invention device stores audio files such as music and books, but not limited to other types of files. The said invention is a standalone device not in need of any other source for power, sound transfer, files selection, volume control. The said invention in claim 1, does not need a wifi signal to operate. The audio files the said device plays, is or are, stored directly to the said device.

8. The device as in claim 1, wherein said invention has a touchscreen for viewing downloaded files, battery charge, the stored users contacts, but not limited to other functions such as deleting, adding files and file naming, a clock or timer. The touch screen has the feature of a keyboard.

9. The device as in claim 1, wherein said invention has a touchscreen that is used for scrolling files. With the touchscreen the files could be highlighted and clicked on by the user's finger. After highlighting a file, the user can click on the highlighted file, selecting that file to play. File on the said invention can be moved to preference with the touchscreen.

10. The device as in claim 1, wherein said inventions components are not limited to size, shape, location.

11. Claim 2, wherein said invention of claim 1, can further comprise of internet connections, wifi capabilities, phone features such as calling and texting, voice command, contact list. The said invention has ability to be used as a smartphone, with the features of making and receiving call and text messages, a talking transmitter, voice activing controls, that the users can uses to speak a command to the said invention, such as calling a contact from the contact list, commanding verbal text messaging, but not limited to other features or commands. The talking transmitter is used by the user for conversations, voice activated text messaging, commanding the said invention to dial a contact, text a contact, but not limited to other functions.

12. The device as in claim 2, wherein said inventions phone calls will be received by the said invention and the incoming voice will be heard through the speakers.

13. The device as in claim 2, wherein said inventions USB port is used to transfer contacts and numbers into said invention from another devices.

14. The device as in claim 2, wherein said invention can have its own phone number or share with the users other devices.

15. The device as in claim 2, wherein said invention has incoming text messages read through the speakers.

16. The device as in claim 2, wherein said invention has a ringer that notifies user of incoming call or text. The ringer is not limited to vibrating and has the function of an on/off button to shut off or turn on the ringer.

17. The device as in claim 2, wherein the said invention has an answer button that controls incoming calls or texts. Pressing the answer once will answer the call. Pressing the answer button twice will ignore the incoming call or text. When the user is listing to audio and a call or text comes in, a beep will be heard through the speakers, but said invention is not limited to vibrating. If a member of the contact list is calling their contact name will be transmitted through the speakers to the user. If the user wishes to answers income calls or texts, the audio will be shut off. To turn audio back on, user presses the play button. If the user wishes to make a call or deliver a text to a number on the contact list, the user presses and holds the answer button shutting off the audio, then the user will say the name of the contact, followed by the word, call. Holding the answer button down will shut off the audio. Once the device responds to the user's voice command, the call will be placed and the said device will start to hear ringing through the speakers until the phone on the other end is answered. Thus the said inventions user will be able to hear the person on the other end through the said inventions headphone speakers and the user will talk into the talking receiver. If the user wishes to place a text message to a contact, the user of the said invention will press and hold the answer button, shutting off the audio, this will be followed by the user saying a name on the contact list followed by the word, text. After the command is given, a beep will be heard and at this point the user will say the text that will be delivered to said contact.

18. The device as in claim 2, wherein said invention, downloads of contacts can be made through the touchscreen. Contacts can be stored from the call history icon or programed in with the use of the touchscreen keyboard. Or contacts can be downloaded through the USB port from another device.

19. The device as in claim 2, wherein said invention is capable of internet connecting. By use of the touchscreen, the user can check for wifi signal, search for a wifi connection, and connect to a wifi connection by use of the touchscreen. Also the touchscreen has an icon for a keyboard. The keyboard is used to label files, add contacts names, add numbers, internet management, but not limited to other functions, such as headphone passwords and wifi passwords. Wifi connections are not limited through the USB connection port to another device. When connected to a wifi signal, the user, through the touchscreen can search and listen to internet programs, radio, podcast, live broadcast, and is not limited to other programs or applications. The said invention is capable of recording and save audio from internet podcast, internet radio, but not limited to any other source. The said invention can also record phone conversations, shows, podcast but is not limited to other audio. The saved recorded audio can be stored, filed, labeled and saved to the said invention for later use.

20. The device as in claim 2, wherein said invention, if the user wishes to change audio files without removing said invention, headphones, they can press and hold the pause button until current audio stops. Then with voice command, they can speak the file they want played.
